(19) United States
(12) Patent Application Publication
(10) Pub. No.: US 2024/0323786 A1
(43) Pub. Date: Sep. 26, 2024

(54) NETWORK HANDOVER METHOD PERFORMED BY AN ELECTRONIC DEVICE AND THE ELECTRONIC DEVICE

(71) Applicant: Samsung Electronics Co., Ltd., Suwon-si (KR)

(72) Inventors: Zhenfei SUN, Suzhou Industrial Park (CN); Xi PENG, Suzhou Industrial Park (CN); Xiaohua TIAN, Suzhou Industrial Park (CN)

(73) Assignee: Samsung Electronics Co., Ltd., Suwon-si (KR)

(21) Appl. No.: 18/594,390

(22) Filed: Mar. 4, 2024

(30) Foreign Application Priority Data
Mar. 24, 2023 (CN) 202310302196.9

(51) Int. Cl. H04W 36/14; H04W 36/00; H04W 88/06

(52) U.S. Cl. CPC H04W 36/14; H04W 36/0058; H04W 36/00837; H04W 36/0094; H04W 88/06

(57) ABSTRACT

A network handover method including determining whether a set of event types to be reported to a first base station includes a first event type in response to determining to hand over an electronic device from a first wireless network to a second wireless network, the first base station corresponding to the first wireless network, determining whether a measurement signal measured by the electronic device is capable of triggering a first event of the first event type in response to determining that the set of event types includes the first event type, modifying the measurement signal to obtain a modified measurement signal in response to determining that the measurement signal is not capable of triggering the first event, the modified measurement signal being capable of triggering the first event, and transmitting a measurement report based on the modified measurement signal to the first base station.

This application claims the benefit of priority to Chinese Patent Application No. 202310302196.9, filed on Mar. 24, 2023, in the Chinese Intellectual Property Office, the disclosure of which is incorporated herein in its entirety by reference.

### BACKGROUND

### 1. Field

The present disclosure relates to a field for communication technology, and more specifically, to a network handover method performed by an electronic device and the electronic device.

### 2. Related Art

According to existing network handover methods, when a user equipment is in a connected state with a base station, the user equipment performs a signal measurement based on report configuration information received from the base station and, when a measured signal of a cell (e.g., a serving cell and/or a neighbor cell) satisfies a threshold of a measurement report event related to network handover, the user equipment transmits a measurement report based on the measured signal of the cell to the base station. Based on the measurement report received from the user equipment and/or other conditions, the base station performs a network handover judgment to determine whether conditions for the user equipment to hand over networks are met. When it is determined that the conditions for the user equipment to hand over networks are met, the user equipment may perform network handover based on network handover indication information received from the base station. That is, if the signal of the cell measured by the user equipment does not meet the threshold of the measurement report event related to network handover, no measurement report related to network handover is transmitted to the base station, and accordingly, the user equipment will continue to reside in an original network.

In some cases, switching of the user equipment from current resident network to another network detected by the user equipment may be beneficial for usage of the user equipment. For example, when the user equipment is a mobile device that is low on power, if the mobile device is switched from the current resident network to another network with lower power consumption, the mobile device may be used for a longer period of time. However, if the signal of the cell (e.g., a neighbor cell) measured by the mobile does not meet the threshold for the measurement report event related to network handover, the mobile device will not be switched to the other network with the lower power consumption even if the user expects to hand over the mobile device from the current network to the other network with lower power consumption.

### SUMMARY

The purpose of the present disclosure is to provide a network handover method performed by an electronic device and the electronic device to address at least the challenges described above.

According to an aspect of embodiments of the present disclosure, there provides a network handover method performed by an electronic device, the method including determining whether a set of event types includes at least one first event type in response to determining to hand over the electronic device from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device, determining whether a measurement signal measured by the electronic device is capable of triggering a first event of the at least one first event type in response to determining that the set of event types includes the at least one first event type, the measurement signal of the electronic device indicating one of both a signal of the first wireless network and a signal of the second wireless network, or the signal of the second wireless network, modifying the measurement signal to obtain a first modified measurement signal in response to determining that the measurement signal is not capable of triggering the first event, the first modified measurement signal being capable of triggering the first event, and transmitting a first measurement report to the first base station, the first measurement report being based on the first modified measurement signal.

According to embodiments of the present disclosure, when an electronic device is to switch a network in which it resides, the electronic device may prompt the base station to make the electronic device achieve network handover by modifying the signal of the cell measured by the electronic device.

According to embodiments, the at least one first event type includes a B1 type or a B2 type defined in 3GPP specification 38.331.

According to embodiments, the at least one first event type includes the B1 type, the measurement signal is a signal Mn of the second wireless network, and the modifying includes determining whether the signal Mn is greater than a value P1, and modifying the signal Mn to enable the modified signal Mn to trigger a B1 event in response to determining that the signal Mn is greater than the value P1; the at least one first event type includes the B2 type, the measurement signal is a signal Ms of the first wireless network and the signal Mn of the second wireless network, and the modifying includes determining whether the signal Mn is greater than the value P1, and modifying the signal Ms or the signal Mn to enable the modified signal Ms or the modified signal Mn to trigger a B2 event in response to determining that the signal Mn is greater than the value P1; or the at least one first event type includes both of the B1 type and the B2 type, the measurement signal is a signal Mn of the second wireless network, and the modifying includes determining whether the signal Mn is greater than the value P1, and modifying the measurement signal according to a rule to enable the first modified measurement signal to trigger the B1 event or the B2 event, in response to determining that the signal Mn is greater than the value P1.

According to embodiments of the present disclosure, the network handover of the electronic device is achieved by modifying the measurement signal only when Mn is greater than a preset (or alternatively, given) value P1, which avoids making the electronic device reside in a network with an excessively poor signal.

According to embodiments, the modifying the measurement signal according to the rule includes comparing the signal Mn to a first threshold T1 and a second threshold T2, the first threshold T1 being defined in the B1 event, and the second threshold T2 being defined in the B2 event, and modifying the measurement signal based on a result of the comparing to enable the first modified measurement signal to trigger the B1 event or the B2 event.

According to embodiments, the signal Mn, the first threshold T1 and the second threshold T2 each represents a corresponding value, and the modifying the measurement signal based on the result of the comparing includes modifying the signal Mn to enable the modified signal Mn to trigger the B1 event in response to T1-Mn not being greater than T2-Mn, and modifying the signal Ms or the signal Mn to enable the modified Ms or Mn to trigger the B2 event in response to T1-Mn being greater than T2-Mn.

According to embodiments of the present disclosure, a priority may be given to triggering an event that is actually closer to being triggered.

According to embodiments, the method further includes determining whether the set of event types includes at least one second event type in response to determining that the set of event types does not include the at least one first event type, determining whether the measurement signal is capable of triggering a second event of the at least one second event type in response to determining that the set of event types includes the at least one second event type, the second event indicating a worsening of a signal of the first base station, modifying the measurement signal to obtain a second modified measurement signal in response to determining that the measurement signal is not capable of triggering the second event, the second modified measurement signal being capable of triggering the second event, and transmitting a second measurement report to the first base station, the second measurement report being based on the second modified measurement signal.

According to embodiments, the at least one second event type includes an A2 type defined in 3GPP specification 38.331, the measurement signal is a signal Ms of the first wireless network, and the modifying the measurement signal to enable the second modified measurement signal to trigger the second event comprises modifying the signal Ms to enable the modified signal Ms to trigger an A2 event.

According to embodiments of the present disclosure, when events related to network handover are unable to be reported, the second event type may be triggered by modifying the measurement signal to notify the base station that the signal of the network in which the electronic device currently resides is too poor, which may prompt the base station to enable the electronic device to achieve handover to a low-power network.

According to embodiments, the method further includes determining that the electronic device is to hand over from the first wireless network to the second wireless network based on the second wireless network being searched by the electronic device and at least one of the following conditions is met, a battery level of the electronic device being below a power threshold, a data throughput of the electronic device being less than a throughput threshold, or a screen of the electronic device being in a closed state, wherein a power consumption of the electronic device connected to the first wireless network is greater than a power consumption of the electronic device connected to the second wireless network.

According to embodiments of the present disclosure, when at least one of the above conditions is met, the usage of the electronic device may be extended if the electronic device is made to be switched to the second wireless network by modifying the measurement signal.

According to an aspect of embodiments of the present disclosure, there provides a network handover method, including determining, by an electronic device, whether a set of event types includes at least one first event type in response to determining that the electronic device is to hand over from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device, determining, by the electronic device, whether a measurement signal measured by the electronic device is capable of triggering a first event of the at least one first event type, the measurement signal indicating one of both a signal of the first wireless network and a signal of the second wireless network, or the signal of the second wireless network, modifying, by the electronic device, the measurement signal to enable the modified measurement signal to trigger the first event in response to determining that the measurement signal is not capable of triggering the first event, transmitting, by the electronic device, a measurement report to the first base station, the measurement report being based on the modified measurement signal, generating, by the first base station, network handover indication information based on the measurement report in response to receiving the measurement report, and transmitting, by the first base station, the network handover indication information to the electronic device.

According to an aspect of embodiments of the present disclosure, there provides an electronic device including processing circuitry configured to determine whether a set of event types includes at least one first event type in response to determining to hand over the electronic device from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device, determine whether a measurement signal measured by the electronic device is capable of triggering a first event of the at least one first event type in response to determining that the set of event types includes the at least one first event type, the measurement signal of the electronic device indicating one of both a signal of the first wireless network and a signal of the second wireless network, or the signal of the second wireless network, modify the measurement signal to obtain a first modified measurement signal in response to determining that the measurement signal is not capable of triggering the first event, the first modified measurement signal being capable of triggering the first event, and transmit a first measurement report to the first base station, the first measurement report being based on the first modified measurement signal.

According to embodiments, the at least one first event type includes a B1 type or a B2 type defined in 3GPP specification 38.331.

According to embodiments, the at least one first event type includes the B1 type, the measurement signal is a signal Mn of the second wireless network, and the processing circuitry is configured to determine whether the signal Mn is greater than a value P1, and modify the signal Mn to enable the modified signal Mn to trigger a B1 event in response to determining that the signal Mn is greater than the value P1; the at least one first event type includes the B2 type, the measurement signal is a signal Ms of the first wireless network and the signal Mn of the second wireless network, and the processing circuitry is configured to determine whether the signal Mn is greater than the value P1, and modify the signal Ms or the signal Mn to enable the modified signal Ms or the modified signal Mn to trigger a B2 event in response to determining that the signal Mn is greater than the value P1; or the at least one first event type includes both of the B1 type and the B2 type, the measurement signal is a signal Mn of the second wireless network, and the processing circuitry is configured to determine whether the signal Mn is greater than the value P1, and modify the measurement signal to enable the first modified measurement signal to trigger a B1 event or a B2 event in response to determining that the signal Mn is greater than the value P1.

According to embodiments, the at least one first event type includes both of the B1 type and the B2 type, and the processing circuitry is configured to compare the signal Mn to a first threshold T1 and a second threshold T2, the first threshold T1 being defined in the B1 event, and the second threshold T2 being defined in the B2 event, and modify the measurement signal based on a result of the comparison to enable the first modified measurement signal to trigger the B1 event or the B2 event.

According to embodiments, the signal Mn, the first threshold T1 and the second threshold T2 each represents a corresponding value, and the processing circuitry is configured to modify the signal Mn to enable the modified signal Mn to trigger the B1 event in response to T1-Mn not being greater than T2-Mn, and modify the signal Ms or the signal Mn to enable the modified signal Ms or the modified signal Mn to trigger the B2 event in response to T1-Mn being greater than T2-Mn.

According to embodiments, the processing circuitry is configured to determine whether the set of event types includes at least one second event type in response to determining that the set of event types does not include the at least one first event type, determine whether the measurement signal is capable of triggering a second event the at least one second event type in response to determining that the set of event types includes the at least one second event type, the second event indicating a worsening of a signal of the first base station, modify the measurement signal to obtain a second modified measurement signal in response to determining that the measurement signal is not capable of triggering the second event, the second modified measurement signal being capable of triggering the second event, and transmit a second measurement report to the first base station, the second measurement report being based on the second modified measurement signal.

According to embodiments, the at least one second event type includes an A2 type defined in 3GPP specification 38.331, the measurement signal is a signal Ms of the first wireless network, and the processing circuitry is configured to modify the signal Ms to enable the modified signal Ms to trigger an A2 event.

According to embodiments, the processing circuitry is configured to determine that the electronic device is to hand over from the first wireless network to the second wireless network based on the second wireless network being searched by the electronic device and at least one of the following conditions is met, a battery level of the electronic device being below a power threshold, a data throughput of the electronic device being less than a throughput threshold, or a screen of the electronic device being in a closed state, wherein a power consumption of the electronic device connected to the first wireless network is greater than a power consumption of the electronic device connected to the second wireless network.

According to an aspect of embodiments of the present disclosure, there provides a communication system, including an electronic device configured to determine whether a set of event types includes at least one first event type in response to determining to hand over the electronic device from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device, determine whether a measurement signal measured by the electronic device is capable of triggering a first event of the at least one first event type in response to determining that the set of event types includes the at least one first event types, the measurement signal of the electronic device indicating one of both a signal of the first wireless network and a signal of the second wireless network, or the signal of the second wireless network, modify the measurement signal of the electronic device to enable the modified measurement signal to trigger the first event in response to determining that the measurement signal is not capable of triggering the first event, and transmit a measurement report to the first base station, the measurement report being based on the modified measurement signal; and the first base station configured to generate network handover indication information based on the measurement report in response to receiving the measurement report, and transmit the network handover indication information to the electronic device.

According to an aspect of embodiments of the present disclosure, there provides an electronic device including at least one processor; a memory storing a computer program that, when executed by the at least one processor, causes the at least one processor to implement the network handover method described as above.

According to an aspect of embodiments of the present disclosure, there provides a non-transitory computer-readable storage medium storing a computer program that, when executed by at least one processor, causes the at least one processor to implement the network handover method described as above.

### BRIEF DESCRIPTION OF THE DRAWINGS

The above and other purposes and features of embodiments of the present disclosure will become more clear through the following descriptions made in conjunction with the figures schematically illustrating embodiments, in which:

FIG. 1 is a system diagram illustrating an example of an environment including an electronic device according to embodiments;

FIG. 2 is a schematic diagram illustrating an example of network handover of an electronic device based on communication with a base station, according to embodiments;

FIG. 3 is a flowchart illustrating a network handover method performed by an electronic device in accordance with embodiments of the present disclosure;

FIG. 4 is a block diagram illustrating a structure of an electronic device according to embodiments of the present disclosure;

FIG. 5 is a block diagram illustrating a structure of a communication system according to embodiments of the present disclosure; and

FIG. 6 is a block diagram illustrating a structure of an electronic device according to embodiments of the present disclosure.

### DETAILED DESCRIPTION

Hereinafter, embodiments of the present disclosure are described with reference to the accompanying drawings, in which like reference numerals are used to depict the same or similar elements, features, and structures. However, the present disclosure is not intended to be limited by embodiments described herein to a specific example and it is intended that the present disclosure covers all modifications, equivalents, and/or alternatives of the present disclosure, provided they come within the scope of the appended claims and their equivalents. The terms and words used in the following description and claims are not limited to their dictionary meanings, but, are merely used to enable a clear and consistent understanding of the present disclosure. Accordingly, it should be apparent to those skilled in the art that the following description of embodiments of the present disclosure is provided for illustration purpose only and not for the purpose of limiting the present disclosure as defined by the appended claims and their equivalents.

It is to be understood that the singular forms include plural forms, unless the context clearly dictates otherwise. The terms “include” and “have”, used herein, indicate disclosed functions, operations, or the existence of elements, but does not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain examples of the present disclosure, but are not intended to limit the scope of other examples. Unless otherwise indicated herein, all terms used herein, including technical or scientific terms, may have the same (or similar) meanings that are generally understood by a person skilled in the art. In general, terms defined in a dictionary should be considered to have the same (or similar) meanings as the contextual meanings in the related art, and, unless clearly defined herein, should not be understood differently or as having an excessively formal meaning. In any case, even terms defined in the present disclosure are not intended to be interpreted as excluding embodiments of the present disclosure.

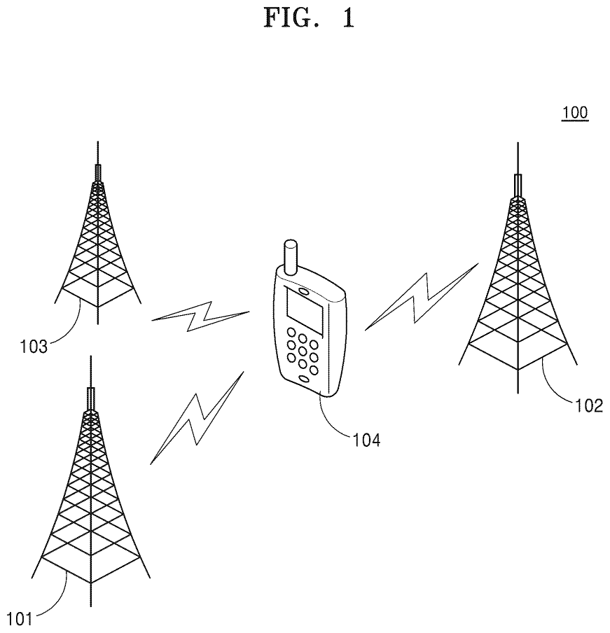

FIG. 1 is a system diagram illustrating an example of an environment including an electronic device according to embodiments.

Referring to FIG. 1, the environment 100 may include a first base station 101, a second base station 102, a third base station 103, and an electronic device 104, wherein the first base station 101, the second base station 102, and the third base station 103 may correspond to different wireless networks, respectively. For example, the first base station 101, the second base station 102, and the third base station 103 may correspond to a 5G network, a 4G network, and a 3G network, respectively.

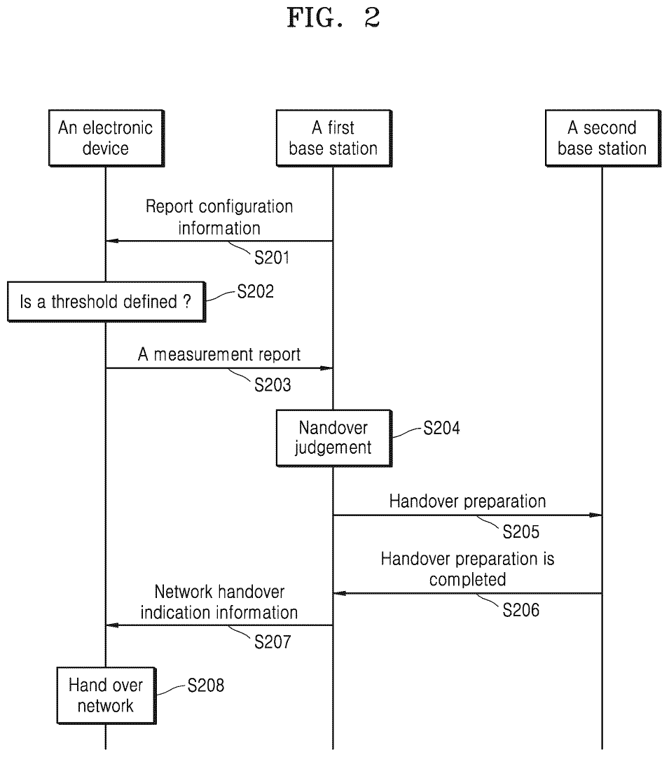

FIG. 2 is a schematic diagram illustrating an example of an electronic device performing network handover based on communication with a base station, according to embodiments.

In embodiments, the electronic device (e.g., the electronic device 104 in FIG. 1) may be in a Radio Resource Control (RRC) connected state with a first base station (e.g., the base station 101, 102, or 103 in FIG. 1).

Referring to FIG. 2, at operation S201, the first base station may transmit, to the electronic device, report configuration information that indicates types of events to be reported to the first base station by the electronic device (e.g., a set of event types), such as at least one of A1-A5, B1, and B2 events defined in 3GPP specification 38.331 incorporated herein by reference. For example, the B1 event indicates that signal quality (e.g., a received signal strength indicator (RSSI), a signal-to-noise ratio (SNR), a signal-to-noise-plus-interference ratio (SINR), etc.) of a heterosystem neighbor cell is above a certain threshold (referred to as a first threshold Thresh1 in the following). A source eNodeB may initiate a heterosystem handover request based on the B1 event when the B1 event is reported. The B2 event indicates that signal quality (e.g., a received signal strength indicator (RSSI), a signal-to-noise ratio (SNR), a signal-to-noise-plus-interference ratio (SINR), etc.) of a serving cell is below a certain threshold (referred to as a second threshold Thresh2 in the following) and that the signal quality of the heterosystem neighbor cell is above a certain threshold (referred to as a third Thresh3). The source eNodeB may initiate a heterosystem handover request based on the B2 event when the B2 event is reported. Accordingly, the B1 event and the B2 event may be considered as being associated with the handover of the electronic device.

In embodiments, the electronic device may be located in a first cell corresponding to the first base station, a second cell corresponding to a second base station and/or a third cell corresponding to a third base station. When the electronic device 104 is in a connected state with the first base station, the first cell is a serving cell, and the second cell and/or the third cell is a neighbor cell of the first cell.

At operation S202, the electronic device may determine whether a measured signal of a cell satisfies a threshold defined in an event to be reported to the first base station.

At operation S203, when the signal of the cell measured by the electronic device satisfies the threshold defined in the event to be reported to the first base station, a measurement report based on the measured signal is transmitted to the first base station. As an example, if the configuration information indicates the electronic device that a B1 event is to be reported, when the signal of the neighbor cell (e.g., the second cell or the third cell) measured by the electronic device is greater than the threshold defined in the B1 event, the B1 event is triggered and the electronic device transmits a measurement report based on the measured signal of the neighbor cell to the first base station.

For example, as the electronic device moves, if the measured signal of the second cell becomes greater than the first threshold, the B1 event is triggered and the electronic device transmits a measurement report based on the measured signal of the second cell to the first base station.

At operation S204, after the first base station receives the measurement report, the first base station may determine whether a handover condition for switching the electronic device from a network corresponding to the first base station to a second network corresponding to the second base station is met at least based on the received measurement report.

At operation S205, when it is determined that the condition is met, the first base station transmits, to the second base station, ready information instructing the second base station to prepare network handover for the electronic device.

At operation S206, when the second base station completes the preparation, information indicating completion of the preparation is transmitted to the first base station.

At operation S207, the first base station, upon receipt of the information indicating the completion of the preparing, transmits network handover indication information to the electronic device.

At operation S208, the electronic device switches from the network corresponding to the first base station to the network corresponding to the second base station after receiving the network handover indication information.

According to relevant network handover methods, if only the B1 event is the event to be reported, only when a signal of a neighbor cell (e.g., the second cell) measured by the electronic device triggers the B1 event, the electronic device may transmit a measurement report to the first base station to prompt the first base station to hand over the electronic device from, for example, a 5G network to, for example, a 4G network.

In some cases, for example, when battery power of the electronic device is low, data throughput of the electronic device is low and/or screen of the electronic device is off, and the usage duration of the electronic device may be extended due to power consumption of a 4G network being less than that of a 5G network if the electronic device is switched from the 5G network to the 4G network.

However, if the signal of the neighbor cell measured by the electronic device 104 is not greater than the first threshold, the electronic device will not transmit a measurement report and therefore will not receive network handover indication information transmitted by the first base station, which leads to the electronic device 104 being unable to timely hand over from the 5G network to the 4G network.

A network handover method, an electronic device and a communication system according to embodiments of the present disclosure address at least the above-mentioned challenges in the related technology.

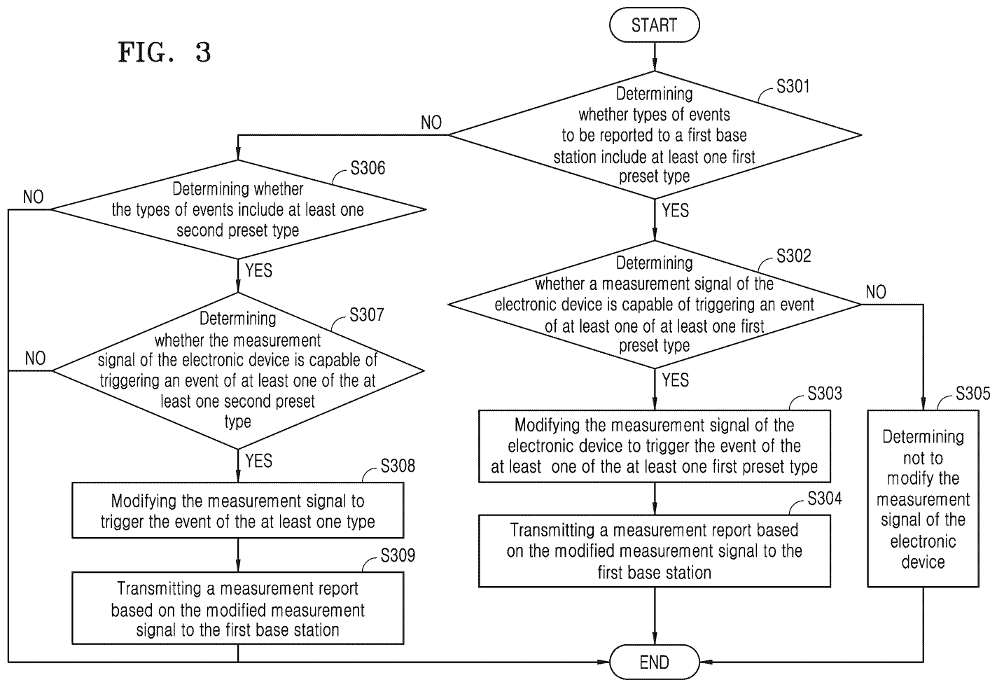

FIG. 3 is a flow chart illustrating a network handover method performed by an electronic device according to embodiments of the present disclosure.

Referring to FIG. 3, at operation S301, it is determined whether types of events to be reported to a first base station (e.g., the set of event types) by an electronic device include at least one first preset (or alternatively, given) type (referred to hereinafter as “at least one first preset type” or “at least one first event type”), in response to determining that the electronic device is to hand over from a first wireless network corresponding to a first base station (e.g., a primary serving cell, serving cell, etc.), to which the electronic device is RRC-connected, to a second wireless network corresponding to a second base station (e.g., a neighbor cell) detected by the electronic device, wherein events of the at least one first preset type are associated with network handover for the electronic device. As discussed above in connection with FIG. 2, the set of event types may be received from the first base station in the report configuration information. As discussed further below, the determination that the electronic device is to hand over from the first wireless network to the second wireless network may be made by the electronic device based on a battery level of the electronic device, a data throughput of the electronic device, whether a screen of the electronic device is in an open state or a closed state (e.g., whether the screen of the electronic device is in a sleep mode (e.g., not powered), whether a cover of the electronic device is placed over the screen such that the screen is no longer visible, etc.). According to embodiments, the hand over from the first wireless network to the second wireless network may include performing the hand over between the first base station and the second base station.

As an example, it may be determined whether the types of events to be reported to the first base station by the electronic device include at least one first preset type based on report configuration information transmitted to the electronic device by the first base station.

For example, if it is determined that the electronic device is to handover from a 5G network to a 4G network, the handover from the 5G network to the 4G network may be done by triggering a B1 event and/or a B2 event related to the handover between the 5G network and the 4G network. That is, for example, when a B1 event is triggered due to a signal of a cell corresponding to the 4G network measured by the electronic device being greater than the first threshold (e.g., whether a received signal strength indicator (RSSI), a signal-to-noise ratio (SNR), a signal-to-noise-plus-interference ratio (SINR), etc., of the signal has a value greater than the first threshold), the electronic device may transmit a measurement report to the first base station to prompt the first base station to enable the electronic device to hand over from the 5G network to the 4G network. However, for example, if the first base station does not configure the B1 event in the report configuration information, the measurement report corresponding to the B1 event will not be transmitted to the first base station even if the measured signal of the neighbor cell is greater than the first threshold.

At operation S302, it is determined whether a measurement signal of (e.g., measured by) the electronic device is capable of triggering an event (e.g., a first event) of the at least one first preset type included in the types of events to be reported to the first base station by the electronic device, in response to determining that the types of events to be reported to the first base station by the electronic device include the at least one first preset type, wherein the measurement signal of the electronic device indicates one of: (1) both a signal of the first wireless network (e.g., transmitted by the first base station) and a signal of the second wireless network (e.g., transmitted by the second base station) measured by the electronic device, or (2) a signal of the second wireless network measured by the electronic device. According to embodiments, the determination of whether the measurement signal is capable of triggering the event includes determining whether a signal quality of the measurement signal (e.g., a received signal strength indicator (RSSI), a signal-to-noise ratio (SNR), a signal-to-noise-plus-interference ratio (SINR), etc.) has a value greater than a threshold corresponding to a type of the first event.

At operation S303, the measurement signal of the electronic device is modified to enable the modified measurement signal (e.g., the first modified measurement signal) to trigger the event of the at least one first preset type included in the types of events to be reported to the first base station by the electronic device, in response to determining that the measurement signal of the electronic device is incapable of triggering the event of the at least one of the at least one first preset type included in the types of events to be reported to the first base station by the electronic device.

As an example, if the types of events to be reported to the first base station by the electronic device include at least one first predetermined (or alternatively, given) type, for example, the B1 and B2 types, the handover from the 5G network to the 4G network may be implemented by triggering a B1 event or a B2 event.

However, in the related art, if the signal of the neighbor cell measured by the electronic device is not greater than a corresponding threshold value, the B1 event or the B2 event will not be triggered. While according to embodiments of the present disclosure, for example, if the signal of a cell (a serving cell and/or a neighbor cell) measured by the electronic device does not trigger the B1 event and/or B2 event, the measured signal of cell (e.g., a signal quality value corresponding to the measurement signal) may then be modified to enable the modified measured signal to trigger the B1 and/or the B2 event.

At operation S304, a measurement report (e.g., a first measurement report) based on the modified measurement signal is transmitted to the first base station.

The first base station, based on the received measurement report, assumes (e.g., interprets, determines, etc.) that the signal actually measured by the electronic device is the modified measurement signal, and therefore, may prompt the first base station to enable the electronic device to perform network handover. For example, the first base station determines, at least based on the received measurement report, that the electronic device satisfies network handover conditions and thereby initiates a heterosystem handover request, such as a request to handover from the 5G network to the 4G network.

At operation S305, it is determined not to modify the measurement signal of the electronic device, in response to determining that the measurement signal of the electronic device is capable of triggering the event of the at least one first preset type included in the types of events to be reported to the first base station by the electronic device.

As an example, the at least one first preset type includes a B1 and/or B2 type defined in 3GPP specification 38.331.

Since B1 events and B2 events are events related to network handover of the electronic device, the base station may be prompted to enable the electronic device to perform network handover by modifying the measurement signal to trigger a B1 event or a B2 event and transmitting a measurement report about the triggered event to the first base station.

As an example, when the at least one first preset type is included in the types of events to be reported to the first base station by the electronic device includes the B1 type, the modifying includes determining whether a signal Mn of the second wireless network (e.g., a signal quality value corresponding to a signal transmitted by the second base station) (also referred to herein as Mn) measured by the electronic device is greater than a preset (or alternatively, given) value P1, and in response to determining that Mn is greater than P1, modifying Mn to enable the modified Mn to trigger a B1 event. According to embodiments the value P1 is included in the report configuration information and/or is defined in 3GPP specification 38.331.

For example, when the electronic device resides in the first wireless network and determines to hand over from the first wireless network to the second wireless network, the first base station corresponding to the first wireless network may be prompted to enable the electronic device to hand over from the first wireless network to the second wireless network by triggering the B1 event. In order to trigger the B1 event corresponding to the handover of the first wireless network and the second wireless network, a condition of Mn+Ofn+Ocn−Hys>Thresh1 is to be satisfied. If the measured Mn does not satisfy this condition but is close to satisfaction of this condition (e.g., Mn is greater than the preset (or alternatively, given) value P1), Mn may be increased by δn1 to enable Mn+Ofn+Ocn−Hys+δn>Thresh1 to trigger the B1 event, such that the measurement signal of the second wireless network measured by the modified electronic device may trigger the B1 event, wherein Mn indicates the measured signal of the second wireless network (e.g., the measured signal of the neighbor cell), Ofn indicates the frequency specific offset of the frequency of the neighbor cell (e.g., offsetFreq defined in the measObjectNR corresponding to the neighbor cell), Ocn indicates the cell specific offset of the neighbor (e.g., cellIndividualOffset corresponding to the frequency of the neighbor cell as defined in the meanObjectNR), and Hys indicates the hysteresis parameter of the A1 event as defined in 3GPP specification 38.331. According to embodiments the threshold value Thresh1 is included in the report configuration information and/or is defined in 3GPP specification 38.331. According to embodiments, value δn1 may be a design parameter determined through empirical study.

That is, the B1 event is triggered and the B1 event is reported to the first base station by modifying the measured signal of the second wireless network, which may prompt the first base station to cause the electronic device to hand over from the first wireless network to the second wireless network.

As an example, when the at least one first preset type included in the types of events to be reported to the first base station by the electronic device includes the B2 type, the modifying may include determining whether Mn is greater than a preset (or alternatively, given) value P1, and in response to determining that Mn is greater than P1, modifying a signal Ms of a primary serving cell corresponding to the first wireless network (e.g., a signal quality value corresponding to a signal transmitted by the first base station) (also referred to herein as Ms) measured by the electronic device and/or Mn to enable the modified Ms and Mn to trigger a B2 event.

For example, when the electronic device resides in the first wireless network and determines that a handover from the first wireless network to the second wireless network is to be performed, the first base station corresponding to the first network may be prompted to cause the electronic device to hand over from the first wireless network to the second wireless network by triggering a B2 event. In order to trigger the B2 event, a condition of Ms+Hys<Thresh2 and Mn+Ofn+Ocn−Hys>Thresh3 is to be satisfied. If the above condition is not be met and the measured Mn is not too small (e.g., Mn is greater than the predetermined (or alternatively, given) value P1), Ms and/or Ms may be modified to enable the modified Ms and Mn to meet the condition for triggering the B2 event to trigger the B2 event. For example, if Ms+Hys≥Thresh2, Ms may be reduced by δs1 to enable Ms+Hys-δs1<Thresh2, and if Mn+Ofn+Ocn−Hys≤Thresh3, Mn may be increased by δn2 to make Mn+Ofn+Ocn−Hys+on2 Thresh3, wherein Ms indicates the signal of the primary serving cell corresponding to the first wireless network measured by the electronic device. That is, the B2 event is triggered and the B2 event is reported to the first base station by modifying the measured signal of the first wireless network and/or the signal of the second wireless network, which may prompt the first base station to cause the electronic device to hand over from the first wireless network to the second wireless network. According to embodiments, each of the threshold values Thresh2 and Thresh3 is included in the report configuration information and/or is defined in 3GPP specification 38.331. According to embodiments, each of values δs1 and δn2 may be a design parameter determined through empirical study.

As an example, when the at least one first preset type included in the types of events to be reported to the first base station by the electronic device includes both of the B1 and B2 types, the modifying includes modifying the measurement signal according to a preset (or alternatively, given) rule to enable the modified measurement signal to trigger a B1 event or a B2 event when Mn is greater than P1.

That is, by triggering one of the B1 event and B2 event, the first base station is prompted to enable the electronic device to hand over from the first wireless network to the second wireless network.

As described above, the measurement signal is modified to trigger the B1 event or the B2 event only when Mn is greater than P1, this is because it is indicated that the network signal of the neighbor cell (e.g., the signal quality of the signal transmitted by the second base station) is poorer (e.g., is lower) if Mn is too small, and handover to the network for the neighbor cell will significantly affect communication quality.

As an example, the modifying the measurement signal according to the preset (or alternatively, given) rule to enable the modified measurement signal to trigger the B1 event or the B2 event may include comparing T1-Mn with T2-Mn, wherein T1 indicates a threshold defined in the B1 event and T2 indicates a threshold corresponding to Mn defined in the B2 event, and modifying the measurement signal based on a result of the comparing, to enable the modified measurement signal to trigger the B1 event or the B2 event.

As an example, the modifying the measurement signal based on the result of the comparing to enable the modified measurement signal to trigger the B1 event or the B2 event may include modifying Mn to enable the modified Mn to trigger the B1 event when T1-Mn is not greater than T2-Mn, and modifying Ms and/or Mn to enable the modified Ms and Mn to trigger the B2 event, when T1-Mn is greater than T2-Mn.

When T1-Mn is not greater than T2-Mn, it means that the B1 event is closer to being triggered, therefore, Mn is selected to be modified to trigger the B1 event. When T1-Mn is greater than T2-Mn, it means that the B2 event is closer to being triggered, therefore, Ms and/or Mn is selected to be modified to trigger the B2 event.

The above predetermined (or alternatively, given) rule is only an example, and embodiments are not limited thereto. For example, when the at least one first preset type included in the types of events to be reported to the first base station by the electronic device includes both the B1 and B2 types, the B1 event or the B2 event may be selected to be triggered according to a priority (e.g., an event type for which the measured signal is closer to meeting the corresponding threshold may be selected to be triggered). For example, when the at least one first preset type included in the types of events to be reported to the first base station by the electronic device includes both of the B1 and B2 types, the measurement signal may be modified to trigger a B1 event.

Examples of modifying Mn to enable the modified Mn to trigger a B1 event and examples of modifying Mn and/or Ms to enable the modified Mn and Ms to trigger a B2 event have been described above and will not be repeated here.

Referring back to FIG. 3, at operation S306, it is determined whether the types of events to be reported to the first base station by the electronic device include at least one second preset (or alternatively, given) type (also referred to herein as “at least one second preset type” or “at least one second event type”), in response to determining that the types of events to be reported to the first base station by the electronic device do not include the at least one first preset type.

At operation S307, it is determined whether the measurement signal of the electronic device is capable of triggering an event (e.g., a second event) of at least one of the at least one second preset type included in the types of events to be reported to the first base station by the electronic device, in response to determining that the types of events to be reported to the first base station by the electronic device include at least one second preset type, wherein an event of the at least one second preset type indicates that a signal of a serving cell in which the electronic device is located measured by the electronic device becomes worse (e.g., that a signal quality value of a signal transmitted by the first base station decreases).

As an example, the event of the at least one second preset type includes an A2 event as defined in 3GPP specification 38.331.

At operation S308, the measurement signal is modified to enable the modified measurement signal (e.g., the second modified measurement signal) to trigger the event of the at least one of the at least one second preset type included in the types of events to be reported to the first base station by the electronic device, in response to determining that the measurement signal of the electronic device is incapable of triggering the event of the at least one second preset type included in the types of events to be reported to the first base station by the electronic device.

As an example, when the at least one second preset type included in the types of events to be reported to the first base station by the electronic device includes the A2 type, if Ms does not satisfy a condition of Ms+Hys<Thresh4, Ms may be reduced by δs2 to make Ms+Hys−δs2 Thresh4, wherein Thresh4 indicates a threshold corresponding to an A2 event. In this way, an A2 event may be triggered by modifying Ms. According to embodiments, the threshold value Thresh42 is included in the report configuration information and/or is defined in 3GPP specification 38.331. According to embodiments, the value δs2 may be a design parameter determined through empirical study.

At operation S309, a measurement report (e.g., a second measurement report) based on the modified measurement signal capable of triggering the event of the at least one second preset type included in the types of events to be reported to the first base station by the electronic device is transmitted to the first base station.

Upon receipt of the measurement report, the first base station considers that the signal (e.g., the signal quality) of the first network measured by the electronic device has become insufficient (e.g., poor), thereby prompting the first base station to configure an event related to a network handover of the electronic device, for example, a B1 and/or B2 event, for the electronic device. According to embodiments, the first base station may configure the event related to the network handover by operations S205, S206, S207 and S208 discussed above in connection with FIG. 2, or operations similar thereto. According to embodiments, after the hand over is completed, the electronic device may perform communication (e.g., transmit communication signals to and/or receive communications signals from) the second base station via the second wireless network. According to embodiments, after the handover is completed, the electronic device may perform communication with another electronic device via the second base station.

As an example, the method further includes determining that the electronic device is to hand over from the first wireless network to the second wireless network when the second wireless network is searched by the electronic device and at least one of the following conditions is met: a battery level of the electronic device being below a power threshold, a data throughput of the electronic device being less than a throughput threshold, and/or a screen of the electronic device being in a closed state, wherein a power consumption of the electronic device residing in (e.g., connected to) the first wireless network is greater than a power consumption of the electronic device residing in (e.g., connected to) the second wireless network.

When the battery level of the electronic device is below the power threshold, the data throughput of the electronic device is less than the throughput threshold, or the screen of the electronic device is in the closed state, it may not be beneficial for the electronic device to reside in the network with high power consumption, and therefore handover for the electronic device from the network with high power consumption to the network with low power consumption may extend usage time of the electronic device.

According to an aspect of embodiments of the present disclosure, there is provided a network handover method including the operations of: in response to determining that the electronic device is to hand over from a first wireless network corresponding to a first base station to which the electronic device is RRC-connected to a second wireless network corresponding to a second base station detected by the electronic device, determining, by the electronic device, whether types of events to be reported to the first base station by the electronic device include at least one first preset type, wherein events of the at least one first preset type are associated with network handover for the electronic device; in response to determining that the types of events to be reported to the first base station by the electronic device include the at least one first preset type, determining, by the electronic device, whether a measurement signal of the electronic device is capable of triggering an event of the at least one first preset type included in the types of events to be reported to the first base station by the electronic device, wherein the measurement signal of the electronic device indicates both a signal of the first wireless network and a signal of the second wireless network measured by the electronic device or the signal of the second wireless network measured by the electronic device; in response to determining that the measurement signal of the electronic device is incapable of triggering an event of the at least one first preset type included in the types of events to be reported to the first base station by the electronic device, modifying, by the electronic device, the measurement signal of the electronic device to enable the modified measurement signal to trigger an event of the at least one first preset type included in the types of events to be reported to the first base station by the electronic device; transmitting, by the electronic device, a measurement report based on the modified measurement signal to the first base station; and in response to receiving the measurement report, the first base station generating handover indication information based on the measurement report, and transmitting the network handover indication information to the electronic device.

As an example, the first base station generating network handover indication information based on the measurement report includes the operations of: determining, at least based on the measurement report, whether conditions for the electronic device to handover networks are met; when it is determined that the conditions are met, transmitting, to the second base station, preparation information instructing the second base station to prepare the network handover for the electronic device; receiving from the second base station information indicating that the preparing is completed; and in response to receipt of the information indicating that the preparing is completed, generating the network handover indication information.

The network handover method according to embodiments of the present disclosure, by modifying the signal of the cell measured by the electronic device at the electronic device, prompts the base station to determine that the electronic device is capable of performing network handover, which may enable the electronic device to be switched to a network desired by the user, such as a network with low power consumption when the signal of the cell measured by the electronic device does not meet the network handover conditions but the electronic device would benefit from a hand over between networks.

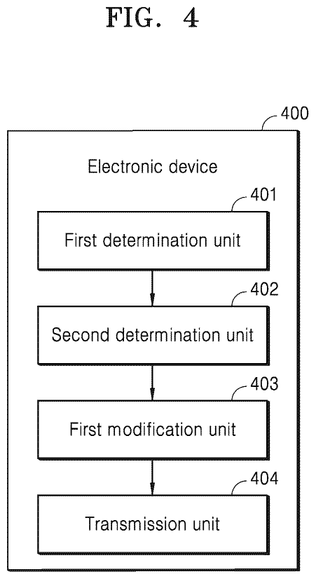

The network handover methods according to embodiments of the present disclosure are described above with reference to FIGS. 1 to 3, and an electronic device and a communication system according to embodiments of the present disclosure are described below with reference to FIG. 4-FIG. 6.

FIG. 4 is a block diagram illustrating a structure of an electronic device 400 according to embodiments of the present disclosure.

Referring to FIG. 4, the electronic device 400 may include a first determination unit 401, a second determination unit 402, a first modification unit 403 and/or a transmission unit 404. Those skilled in the art should understand that the electronic device 400 may additionally include other components, and at least one of components in the electronic device 400 may be divided or combined.

As an example, the first determination unit 401 may be configured to, in response to determining that the electronic device is to hand over from a first wireless network corresponding to a first base station, to which the electronic device is RRC-connected to, a second wireless network corresponding to a second base station detected by the electronic device, determine whether types of events to the first base station by the electronic device include at least one first preset type, wherein events of the first preset type are associated with network handover for the electronic device. As an example, the second determination unit 402 may be configured to, in response to determining that the types of events to be reported to the first base station by the electronic device include at least one first preset type, determine whether a measurement signal of the electronic device is capable of triggering an event of at least one of at least one first preset type included in the types of events to be reported to the first base station by the electronic device, wherein the measurement signal of the electronic device indicates both a signal of the first wireless network and a signal of the second wireless network measured by the electronic device or the signal of the second wireless network measured by the electronic device.

As an example, the first modification unit 403 may be configured to, in response to determining that the measurement signal of the electronic device is incapable of triggering the event of the at least one of the at least one first preset type included in the types of events to be reported to the first base station by the electronic device, modify the measurement signal of the electronic device to enable the modified measurement signal to trigger the event of the at least one of the at least one first preset type included in the types of events to be reported to the first base station by the electronic device.

As an example, the transmission unit 404 may be configured to transmit a measurement report based on the modified measurement signal to the first base station.

As an example, the first preset type includes the B1 and/or B2 type defined in 3GPP specification 38.331.

As an example, when the at least one first preset type included in the types of events to be reported to the first base station by the electronic device includes the B1 type, the first modification unit 403 is configured to determine whether a signal Mn of the second wireless network measured by the electronic device is greater than a preset value P1, and modify Mn to enable the modified Mn to trigger a B1 event, in response to determining that Mn is greater than P1. When the at least one first preset type included in the types of events to be reported to the first base station by the electronic device includes the B2 type, the first modification unit 403 is configured to determine whether Mn is greater than the preset (or alternatively, given) value P1, and modify a signal Ms of a primary serving cell corresponding to the first wireless network measured by the electronic device and/or Mn to enable the modified Ms and Mn to trigger a B2 event, in response to determining that Mn is greater than P1. When the at least one first preset type included in the types of events to be reported to the first base station by the electronic device includes the B1 and B2 types, the first modification unit 403 is configured to modify the measurement signal according to a preset (or alternatively, given) rule to enable the modified measurement signal to trigger a B1 event or a B2 event, when Mn is greater than P1.

As an example, when the at least one first preset type included in the types of events to be reported to the first base station by the electronic device includes the B1 and B2 types, the first modification unit 403 is configured to compare T1-Mn with T2-Mn, and modify the measurement signal based on a result of the comparing to enable the modified measurement signal to trigger the B1 event or the B2 event, wherein T1 indicates a threshold defined in the B1 event and T2 indicates a threshold corresponding to Mn defined in the B2 event.

As an example, the first modification unit 403 is configured to modify Mn to enable the modified Mn to trigger the B1 event when T1-Mn is not greater than T2-Mn, and modify Ms and/or Mn to enable the modified Ms and Mn to trigger the B2 event, when T1-Mn is greater than T2-Mn.

As an example, the electronic device 400 further includes a third determination unit (not shown) configured to determine whether the types of events to be reported to the first base station by the electronic device include at least one second preset type, in response to determining that the types of events to be reported to the first base station by the electronic device do not include at least one first preset type; a fourth determination unit (not shown) configured to determine whether the measurement signal of the electronic device is capable of triggering an event of at least one of the at least one second preset type included in the types of events to be reported to the first base station by the electronic device, in response to determining that the types of events to be reported to the first base station by the electronic device include at least one second preset type, wherein an event of the second preset type indicates that a signal of a serving cell in which the electronic device is located measured by the electronic device becomes worse; a second modification unit (not shown) configured to, in response to determining that the measurement signal of the electronic device is incapable of triggering the event of the at least one of the at least one second preset type included in the types of events to be reported to the first base station by the electronic device, modify the measurement signal to enable the modified measurement signal to trigger the event of the at least one of the at least one second preset type included in the types of events to be reported to the first base station by the electronic device, and the transmission unit 404 is configured to transmit a measurement report based on the modified measurement signal capable of triggering the event of the at least one of the at least one second preset type included in the types of events to be reported to the first base station by the electronic device to the first base station.

As an example, when the at least one second preset type included in the types of events to be reported to the first base station by the electronic device includes an A2 type defined in 3GPP specification 38.331, the second modification unit is configured to modify a signal Ms of a primary serving cell corresponding to the first wireless network measured by the electronic device to enable the modified Ms to trigger an A2 event.

As an example, the electronic device 400 further includes a fifth determination unit (not shown) configured to determine that the electronic device is to hand over from the first wireless network to the second wireless network, when the second wireless network is searched by the electronic device and at least one of the following conditions is met: a battery level of the electronic device being below a power threshold, a data throughput of the electronic device being less than a throughput threshold, and a screen of the electronic device being in a closed state, wherein a power consumption of the electronic device residing in the first wireless network is greater than a power consumption of the electronic device residing in the second wireless network.

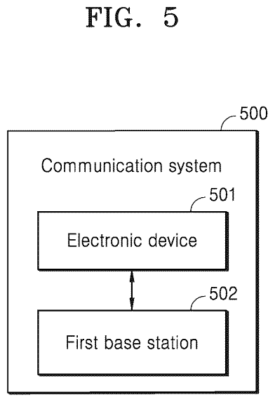

FIG. 5 is a block diagram illustrating a structure of a communication system 500 according to embodiments of the present disclosure.

Referring to FIG. 5, the communication system 500 may include: an electronic device 501 and a first base station 502.

As an example, the electronic device 501 may be configured to perform the operations of: in response to determining that the electronic device is to hand over from a first wireless network corresponding to a first base station to which the electronic device is RRC-connected to a second wireless network corresponding to a second base station detected by the electronic device, determine whether types of events to be reported to the first base station by the electronic device include at least one first preset type, wherein events of the first preset type are associated with network handover for the electronic device; in response to determining that the types of events to be reported to the first base station by the electronic device include at least one first preset type, determine whether a measurement signal of the electronic device is capable of triggering an event of at least one of at least one first preset type included in the types of events to be reported to the first base station by the electronic device, wherein the measurement signal of the electronic device indicates both a signal of the first wireless network and a signal of the second wireless network measured by the electronic device or the signal of the second wireless network measured by the electronic device; and in response to determining that the measurement signal of the electronic device is incapable of triggering an event of at least one of the at least one first preset type included in the types of events to be reported to the first base station by the electronic device, modify the measurement signal of the electronic device to enable the modified measurement signal to trigger an event of at least one of at least one first preset type included in the types of events to be reported to the first base station by the electronic device, and transmit a measurement report based on the modified measurement signal to the first base station.

As an example, the first base station 502 may be configured to generate network handover indication information based on the measurement report and transmit the network handover indication information to the electronic device, in response to receiving the measurement report.

As an example, the first base station 502 may be configured to determine, at least based on the measurement report, whether conditions for the electronic device to handover networks are met, transmit, to the second base station, preparation information instructing the second base station to prepare the network handover for the electronic device when it is determined that the conditions are met, receive from the second base station information indicating that the preparation is completed, and generate the network handover indication information, in response to receipt of the information indicating that the preparing is completed.

According to embodiments of the present disclosure, there provides an electronic device including a processor, and a memory storing a computer program, when executed by the processor, implementing the network handover method as described above.

According to embodiments of the present disclosure, there provides a computer-readable storage medium storing a computer program, when executed by a processor, implementing the network handover method as described above.

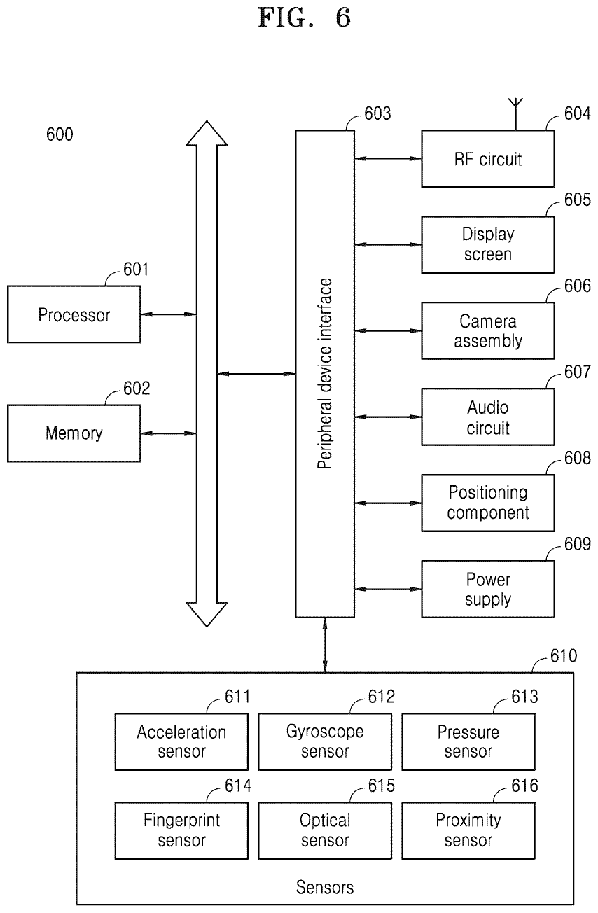

FIG. 6 is a structural block diagram illustrating an electronic device according to embodiments of the present disclosure. The electronic device 600 may be, for example, a smart phone, a tablet computer, an MP3 (Moving Picture Experts Group Audio Layer III) player, MP4 (Moving Picture Experts Group Audio Layer IV) Player, laptop or desktop computer. The electronic device 600 may also be called user equipment, portable terminal, laptop terminal, desktop terminal and other names.

Generally, the electronic device 600 includes a processor 601 and a memory 602.

The processor 601 may include one or more processing cores, such as a 4-cores processor, an 8-cores processor, and so on. The processor 601 may be implemented in at least one hardware form of DSP (Digital Signal Processing), FPGA (Field Programmable Gate Array), PLA (Programmable Logic Array), etc. The processor 601 may also include a main processor and a slave processor. The main processor is a processor used to process data in an awake state, also called a CPU (Central Processing Unit); the slave processor is a low-power processor used to process data in a standby state. In embodiments, the processor 601 may be integrated with a GPU (Graphics Processing Unit) used to render and draw content to be displayed on the display screen. In embodiments, the processor 601 may further include an AI (Artificial Intelligence) processor used to process calculation operations related to machine learning.

The memory 602 may include one or more computer-readable storage media, which may be non-transitory. The memory 602 may also include a high-speed random access memory and a non-volatile memory, such as one or more magnetic disk storage devices and flash memory storage devices. In embodiments, the non-transitory computer-readable storage medium in the memory 602 is used to store at least one instruction used to be executed by the processor 601 to implement the network handover methods in the present disclosure.

In embodiments, the electronic device 600 may optionally further include: a peripheral device interface 603 and at least one peripheral device. The processor 601, the memory 602, and/or the peripheral device interface 603 may be connected by a bus or a signal line. Each peripheral device may be connected to the peripheral device interface 603 through a bus, a signal line, or a circuit board. Specifically, the peripheral devices includes: a radio frequency circuit 604, a display screen 605 (e.g., a touch screen), a camera assembly 606 (e.g., a camera), an audio circuit 607, a positioning component 608, and/or a power supply 609.

The peripheral device interface 603 may be used to connect at least one peripheral device related to I/O (Input/Output) to the processor 601 and the memory 602. In embodiments, the processor 601, the memory 602, and the peripheral device interface 603 are integrated on the same chip or circuit board, however embodiments are not limited thereto. In embodiments, any one or two of the processor 601, the memory 602, and/or the peripheral device interface 603 may be implemented on a separate chip or circuit board.

The radio frequency circuit 604 is used for receiving and transmitting RF (Radio Frequency) signals, also called electromagnetic signals. The radio frequency circuit 604 communicates with a communication network and other communication devices through electromagnetic signals. The radio frequency circuit 604 converts electrical signals into electromagnetic signals for transmission, or converts received electromagnetic signals into electrical signals. Alternatively, the radio frequency circuit 604 includes: an antenna system, an RF transceiver, one or more amplifiers, a tuner, an oscillator, a digital signal processor, a codec chipset, a user identity module card, and so on. The radio frequency circuit 604 may communicate with other terminals through at least one wireless communication protocol. The wireless communication protocol includes, but is not limited to: metropolitan area networks, various generations of mobile communication networks (e.g., 2G, 3G, 4G, and 5G), wireless local area networks and/or Wi-Fi (Wireless Fidelity) networks. In embodiments, the radio frequency circuit 604 may also include a circuit related to NFC (Near Field Communication), which is not limited in the present disclosure.

The display screen 605 is used to display a UI (User Interface). The UI may include graphics, text, icons, videos, and any combination thereof. When the display screen 605 is a touch display screen, the display screen 605 also has an ability to collect touch signals on or above the surface of the display screen 605. The touch signal may be input to the processor 601 as a control signal for processing. At this time, the display screen 605 may also be used to provide virtual buttons and/or virtual keyboards, also called soft buttons and/or soft keyboards. In embodiments, the display screen 605 may be one display screen, which is arranged on the front panel of the electronic device 600; in embodiments, the display screen 605 may be at least two display screens 605, which are respectively arranged on different surfaces of the electronic device 600 or in a folded design. In embodiments, the display screen 605 may be a flexible display screen, which is arranged on the curved surface or the folding surface of the electronic device 600. Furthermore, the display screen 605 may also be set as a non-rectangular irregular shape, that is, a special-shaped screen. The display screen 605 may be made of materials such as LCD (Liquid Crystal Display), OLED (Organic Light-Emitting Diode), etc.

The camera assembly 606 is used to capture images or videos. the camera assembly 606 may include a front camera and a rear camera. Generally, the front camera is set on the front panel of the terminal, and the rear camera is set on the back of the terminal. In embodiments, the rear camera is at least two cameras, each of which is a main camera, a depth-of-field camera, a wide-angle camera, and/or a telephoto camera, so as to realize a fusion of the main camera and the depth-of-field camera to realize the background blur function, a fusion of the main camera and the wide-angle camera to realize panoramic shooting and VR (Virtual Reality) shooting function or other fusion shooting functions. In embodiments, the camera assembly 606 may also include a flash. The flash may be a single-color temperature flash or a dual-color temperature flash. Dual color temperature flash refers to a combination of warm light flash and cold light flash, which may be used for light compensation under different color temperatures.

The audio circuit 607 may include a microphone and a speaker. The microphone is used to collect sound waves of the user and the environment, and convert the sound waves into electrical signals and input them to the processor 601 for processing, or input to the radio frequency circuit 604 to implement voice communication. For stereo collection or noise reduction, there may be multiple microphones, which are respectively set in different parts of the electronic device 600. The microphone may also be an array microphone or an omnidirectional collection microphone. The speaker is used to convert the electrical signal from the processor 601 or the radio frequency circuit 604 into sound waves. The speaker may be a traditional thin-film speaker or a piezoelectric ceramic speaker. When the speaker is a piezoelectric ceramic speaker, it may not only convert electrical signals into sound waves that are audible to humans, but also convert electrical signals into sound waves that are inaudible to humans for distance measurement, etc. In embodiments, the audio circuit 607 may also include a headphone jack.

The positioning component 608 is used to locate a current geographic location of the electronic device 600 to implement navigation or LBS (Location Based Service). The positioning component 608 may be a positioning component based on the GPS (Global Positioning System) of the United States, the Beidou system of China, the GLONASS system of Russia, or the Galileo system of the European Union.

The power supply 609 is used to supply power to various components in the electronic device 600. The power supply 609 may be alternating current, direct current, disposable batteries, or rechargeable batteries. When the power supply 609 includes a rechargeable battery, the rechargeable battery may support wired charging or wireless charging. The rechargeable battery may also be used to support fast charging technology.

In embodiments, the electronic device 600 further includes one or more sensors 610. The one or more sensors 610 include, but are not limited to: an acceleration sensor 611, a gyroscope sensor 612, a pressure sensor 613, a fingerprint sensor 614, an optical sensor 615, and/or a proximity sensor 616.

The acceleration sensor 611 may detect the magnitude of acceleration on the three coordinate axes of the coordinate system established by the electronic device 600. For example, the acceleration sensor 611 may be used to detect the components of gravitational acceleration on three coordinate axes. The processor 601 may control the display screen 605 to display the user interface in a horizontal view or a vertical view according to the gravity acceleration signal collected by the acceleration sensor 611. The acceleration sensor 611 may also be used for the collection of game or user motion data.

The gyroscope sensor 612 may detect the body direction and rotation angle of the electronic device 600, and the gyroscope sensor 612 may cooperate with the acceleration sensor 611 to collect the user's 3D actions on the electronic device 600. The processor 601 may implement the following functions according to the data collected by the gyroscope sensor 612: motion sensing (for example, changing the UI according to the user's tilt operation), image stabilization during shooting, game control, and inertial navigation.

The pressure sensor 613 may be disposed on a side frame of the electronic device 600 and/or the lower layer of the display screen 605. When the pressure sensor 613 is arranged on the side frame of the electronic device 600, the user's holding signal for the electronic device 600 may be detected, and the processor 601 performs left and right hand recognition or quick operation according to the holding signal collected by the pressure sensor 613. When the pressure sensor 613 is arranged on the lower layer of the display screen 605, the processor 601 controls an operability control element on the UI according to the user's pressure operation on the display screen 605. The operability control element includes at least one of a button control clement, a scroll bar control element, an icon control element, and/or a menu control element.

The fingerprint sensor 614 is used to collect a user's fingerprint, and the processor 601 identifies the user's identity according to the fingerprint collected by the fingerprint sensor 614, or the fingerprint sensor 614 identifies the user's identity according to the collected fingerprint. When it is recognized that the user's identity is a trusted identity, the processor 601 authorizes the user to perform related sensitive operations, including unlocking a screen, viewing encrypted information, downloading software, paying, and changing settings. The fingerprint sensor 614 may be provided on the front, back or side of the electronic device 600. When the electronic device 600 is provided with a physical button or a manufacturer logo, the fingerprint sensor 614 may be integrated with the physical button or the manufacturer logo.

The optical sensor 615 is used to collect the ambient light intensity. In embodiments, the processor 601 may control the display brightness of the display screen 605 according to the intensity of the ambient light collected by the optical sensor 615. Specifically, when the ambient light intensity is high, the display brightness of the display screen 605 is increased; when the ambient light intensity is low, the display brightness of the display screen 605 is decreased. In embodiments, the processor 601 may also dynamically adjust the shooting parameters of the camera assembly 606 according to the ambient light intensity collected by the optical sensor 615.

The proximity sensor 616, also called a distance sensor, is usually arranged on a front panel of the electronic device 600. The proximity sensor 616 is used to collect a distance between the user and the front of the electronic device 600. In embodiments, when the proximity sensor 616 detects that the distance between the user and the front of the electronic device 600 gradually decreases, the processor 601 controls the display screen 605 to switch from on-screen state to off-screen state; when the proximity sensor 616 detects that the distance between the user and the front of the electronic device 600 gradually increases, the processor 601 controls the display screen 605 to switch from the off-screen state to the on-screen state.

Those skilled in the art may understand that the structure shown in FIG. 6 does not constitute a limitation on the electronic device 600, and may include more or fewer components than shown, or combine certain components, or adopt different component arrangements

According to embodiments of the present disclosure, there may also be provided a computer-readable storage medium storing instructions, when executed by at least one processor, causing the at least one processor to execute the network handover method according to the present disclosure. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and/or any other devices configured to store computer programs and any associated data, data files, and data structures in a non-transitory manner, and provide the computer programs and any associated data, data files, and data structures to the processor or the computer, so that the processor or the computer may execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to embodiments of the present disclosure, a computer program product may also be provided, and instructions in the computer program product may be executed by a processor of a computer device to complete the network handover method.

The network handover method, the electronic device, the electronic apparatus, and the computer-readable storage medium according to embodiments of the present disclosure may prompt the base station to instruct the electronic device to hand over networks.

Conventional devices and methods for performing wireless communication only perform an event-based hand over when an electronic device (e.g., a mobile device) transmits a measurement report to a serving cell indicating that a measured signal quality meets a criterion for hand over (e.g., based on a comparison to a corresponding threshold). Conventional electronic devices, for example, are unable to request the serving cell to perform the event-based hand over in circumstances in which an electronic device would benefit from such a hand over (e.g., to conserve power, etc.). Accordingly, the conventional devices and methods provide insufficient functionality in implementing hand overs resulting in, for example, excessive power consumption in conventional electronic devices.

However, according to embodiments, improved devices and methods are provided for performing event-based hand overs. For example, improved electronic devices, upon determining that it would be beneficial to perform a hand over (e.g., under circumstances in which the electronic device would benefit from lower power consumption), determine whether the measured signal quality meets the criterion for hand over. In response to determining that the measured signal quality does not meet the criterion for hand over, the improved electronic devices modify (e.g., increase or decrease) the measured signal quality such that this modified signal quality meets the criterion (e.g., by meeting the corresponding threshold). By sending a measurement report to the serving cell including the modified signal quality, the improved electronic devices may trigger the serving cell to complete the event-based hand over. Accordingly, the improved devices and methods overcome the deficiencies of the conventional devices and methods to increase hand over implementation functionality and thereby, for example, reduce power consumption in improved electronic devices.

According to embodiments, operations described herein as being performed by the first base station 101, the second base station 102, the third base station 103, the electronic device 104, the electronic device 400, the first determination unit 401, the second determination unit 402, the first modification unit 403, the transmission unit 404, the third determination unit, the fourth determination unit, the second modification unit, the fifth determination unit, the communication system 500, the electronic device 501, the first base station 502, the electronic device 600, the processor 601, the radio frequency circuit 604, the camera assembly 606, the audio circuit 607, the positioning component 608, the one or more sensors 610, the acceleration sensor 611, the gyroscope sensor 612, the pressure sensor 613, the fingerprint sensor 614, the optical sensor 615, and/o the proximity sensor 616 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 602). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Those skilled in the art will easily think of embodiments of the present disclosure after considering the specification and practicing the disclosure disclosed herein. The present disclosure is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and embodiments are to be regarded as exemplary only, and the actual scope and spirit of the present disclosure are pointed out by the following claims.

1. A network handover method performed by an electronic device, the method comprising:
determining whether a set of event types includes at least one first event type in response to determining to hand over the electronic device from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device;
determining whether a measurement signal measured by the electronic device is capable of triggering a first event of the at least one first event type in response to determining that the set of event types includes the at least one first event type, the measurement signal of the electronic device indicating one of,
both a signal of the first wireless network and a signal of the second wireless network, or
the signal of the second wireless network;
modifying the measurement signal to obtain a first modified measurement signal in response to determining that the measurement signal is not capable of triggering the first event, the first modified measurement signal being capable of triggering the first event; and
transmitting a first measurement report to the first base station, the first measurement report being based on the first modified measurement signal.

2. The method of claim 1, wherein the at least one first event type comprises a B1 type or a B2 type defined in 3GPP specification 38.331.

3. The method of claim 2, wherein
the at least one first event type includes the B1 type, the measurement signal is a signal Mn of the second wireless network, and the modifying comprises:
determining whether the signal Mn is greater than a value P1, and
modifying the signal Mn to enable the modified signal Mn to trigger a B1 event in response to determining that the signal Mn is greater than the value P1;
the at least one first event type includes the B2 type, the measurement signal is a signal Ms of the first wireless network and the signal Mn of the second wireless network, and the modifying comprises:
determining whether the signal Mn is greater than the value P1, and
modifying the signal Ms or the signal Mn to enable the modified signal Ms or the modified signal Mn to trigger a B2 event in response to determining that the signal Mn is greater than the value P1; or
the at least one first event type includes both of the B1 type and the B2 type, the measurement signal is a signal Mn of the second wireless network, and the modifying comprises:
determining whether the signal Mn is greater than the value P1, and
modifying the measurement signal according to a rule to enable the first modified measurement signal to trigger the B1 event or the B2 event, in response to determining that the signal Mn is greater than the value P1.

4. The method of claim 3, wherein the modifying the measurement signal according to the rule comprises:
comparing the signal Mn to a first threshold T1 and a second threshold T2, the first threshold T1 being defined in the B1 event, and the second threshold T2 being defined in the B2 event; and
modifying the measurement signal based on a result of the comparing to enable the first modified measurement signal to trigger the B1 event or the B2 event.

5. The method of claim 4, wherein
the signal Mn, the first threshold T1 and the second threshold T2 each represents a corresponding value; and
the modifying the measurement signal based on the result of the comparing comprises:
modifying the signal Mn to enable the modified signal Mn to trigger the B1 event in response to T1-Mn not being greater than T2-Mn, and
modifying the signal Ms or the signal Mn to enable the modified signal Ms or the modified signal Mn to trigger the B2 event in response to T1-Mn being greater than T2-Mn.

6. The method of claim 1, further comprising:
determining whether the set of event types includes at least one second event type in response to determining that the set of event types does not include the at least one first event type;
determining whether the measurement signal is capable of triggering a second event of the at least one second event type in response to determining that the set of event types includes the at least one second event type, the second event indicating a worsening of a signal of the first base station;
modifying the measurement signal to obtain a second modified measurement signal in response to determining that the measurement signal is not capable of triggering the second event, the second modified measurement signal being capable of triggering the second event; and
transmitting a second measurement report to the first base station, the second measurement report being based on the second modified measurement signal.

7. The method of claim 6, wherein
the at least one second event type includes an A2 type defined in 3GPP specification 38.331;
the measurement signal is a signal Ms of the first wireless network; and
the modifying the measurement signal to enable the second modified measurement signal to trigger the second event comprises modifying the signal Ms to enable the modified signal Ms to trigger an A2 event.

8. The method of claim 1, further comprising:
determining that the electronic device is to hand over from the first wireless network to the second wireless network based on the second wireless network being searched by the electronic device and at least one of the following conditions is met,
a battery level of the electronic device being below a power threshold,
a data throughput of the electronic device being less than a throughput threshold, or
a screen of the electronic device being in a closed state,
wherein a power consumption of the electronic device connected to the first wireless network is greater than a power consumption of the electronic device connected to the second wireless network.

9. A network handover method, the method comprising:
determining, by an electronic device, whether a set of event types includes at least one first event type in response to determining that the electronic device is to hand over from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device;
determining, by the electronic device, whether a measurement signal measured by the electronic device is capable of triggering a first event of the at least one first event type, the measurement signal indicating one of,
both a signal of the first wireless network and a signal of the second wireless network, or
the signal of the second wireless network;
modifying, by the electronic device, the measurement signal to enable the modified measurement signal to trigger the first event in response to determining that the measurement signal is not capable of triggering the first event;
transmitting, by the electronic device, a measurement report to the first base station, the measurement report being based on the modified measurement signal;
generating, by the first base station, network handover indication information based on the measurement report in response to receiving the measurement report; and
transmitting, by the first base station, the network handover indication information to the electronic device.

10. An electronic device, comprising:
processing circuitry configured to,
determine whether a set of event types includes at least one first event type in response to determining to hand over the electronic device from a first wireless network to a second wireless network, the set of event types including types of events to be reported to a first base station by the electronic device, the at least one first event type being associated with network handover for the electronic device, the electronic device being connected to the first base station through a radio resource control connection, the first base station corresponding to the first wireless network, and a second base station corresponding to the second wireless network being detected by the electronic device,
determine whether a measurement signal measured by the electronic device is capable of triggering a first event of the at least one first event type in response to determining that the set of event types includes the at least one first event type, the measurement signal of the electronic device indicating one of,
both a signal of the first wireless network and a signal of the second wireless network, or
the signal of the second wireless network,
modify the measurement signal to obtain a first modified measurement signal in response to determining that the measurement signal is not capable of triggering the first event, the first modified measurement signal being capable of triggering the first event, and
transmit a first measurement report to the first base station, the first measurement report being based on the first modified measurement signal.

11. The electronic device of claim 10, wherein the at least one first event type comprises a B1 type or a B2 type defined in 3GPP specification 38.331.

12. The electronic device of claim 11, wherein
the at least one first event type includes the B1 type, the measurement signal is a signal Mn of the second wireless network, and the processing circuitry is configured to:
determine whether the signal Mn is greater than a value P1, and
modify the signal Mn to enable the modified signal Mn to trigger a B1 event in response to determining that the signal Mn is greater than the value P1;
the at least one first event type includes the B2 type, the measurement signal is a signal Ms of the first wireless network and the signal Mn of the second wireless network, and the processing circuitry is configured to:
determine whether the signal Mn is greater than the value P1, and
modify the signal Ms or the signal Mn to enable the modified signal Ms or the modified signal Mn to trigger a B2 event in response to determining that the signal Mn is greater than the value P1; or
the at least one first event type includes both of the B1 type and the B2 type, the measurement signal is a signal Mn of the second wireless network, and the processing circuitry is configured to:
determine whether the signal Mn is greater than the value P1, and
modify the measurement signal to enable the first modified measurement signal to trigger a B1 event or a B2 event in response to determining that the signal Mn is greater than the value P1.

13. The electronic device of claim 12, wherein
the at least one first event type includes both of the B1 type and the B2 type; and
the processing circuitry is configured to:
compare the signal Mn to a first threshold T1 and a second threshold T2, the first threshold T1 being defined in the B1 event, and the second threshold T2 being defined in the B2 event, and
modify the measurement signal based on a result of the comparison to enable the first modified measurement signal to trigger the B1 event or the B2 event.

14. The electronic device of claim 13, wherein
the signal Mn, the first threshold T1 and the second threshold T2 each represents a corresponding value; and
the processing circuitry is configured to:
modify the signal Mn to enable the modified signal Mn to trigger the B1 event in response to T1-Mn not being greater than T2-Mn, and
modify the signal Ms or the signal Mn to enable the modified signal Ms or the modified signal Mn to trigger the B2 event in response to T1-Mn being greater than T2-Mn.

15. The electronic device of claim 10, wherein the processing circuitry is configured to:
determine whether the set of event types includes at least one second event type in response to determining that the set of event types does not include the at least one first event type;
determine whether the measurement signal is capable of triggering a second event the at least one second event type in response to determining that the set of event types includes the at least one second event type, the second event indicating a worsening of a signal of the first base station;
modify the measurement signal to obtain a second modified measurement signal in response to determining that the measurement signal is not capable of triggering the second event, the second modified measurement signal being capable of triggering the second event; and
transmit a second measurement report to the first base station, the second measurement report being based on the second modified measurement signal.

16. The electronic device of claim 15, wherein
the at least one second event type includes an A2 type defined in 3GPP specification 38.331;
the measurement signal is a signal Ms of the first wireless network; and
the processing circuitry is configured to modify the signal Ms to enable the modified signal Ms to trigger an A2 event.

17. The electronic device of claim 10, wherein the processing circuitry is configured to:
determine that the electronic device is to hand over from the first wireless network to the second wireless network based on the second wireless network being searched by the electronic device and at least one of the following conditions is met,
a battery level of the electronic device being below a power threshold,
a data throughput of the electronic device being less than a throughput threshold, or
a screen of the electronic device being in a closed state,
wherein a power consumption of the electronic device connected to the first wireless network is greater than a power consumption of the electronic device connected to the second wireless network.

18. (canceled)

19. A non-transitory computer-readable storage medium storing a computer program that, when executed by at least one processor, causes the at least one processor to implement the network handover method of claim 1.
